(19) United States
(12) Patent Application Publication
(10) Pub. No.: US 2024/0279762 A1
(43) Pub. Date: Aug. 22, 2024

(54) METHOD FOR PRODUCING A ROLLING ELEMENT BEARING COMPONENT, ROLLING ELEMENT BEARING COMPONENT, AND ROLLING ELEMENT BEARING

(71) Applicant: Schaeffler Technologies AG & Co. KG, Herzogenaurach (DE)

(72) Inventors: Johannes Moeller, Schweinfurt (DE); Werner Trojahn, Niederwerrn (DE); Stefan Valentin, Euerbach (DE); Markus Dinkel, Würzburg (DE)

(73) Assignee: Schaeffler Technologies AG & Co. KG, Herzogenaurach (DE)

(21) Appl. No.: 18/561,124

(22) PCT Filed: May 10, 2022
(86) PCT No.: PCT/DE2022/100353

§ 371 Date: Nov. 15, 2023

(30) Foreign Application Priority Data
May 21, 2021 (DE) 10 2021 113 276.2
May 9, 2022 (DE) 10 2022 111 455.4

(51) Int. Cl. C21D 1/607; C21D 1/20; C21D 9/40

(52) U.S. Cl. CPC C21D 1/607; C21D 1/20; C21D 9/40; C21D 2211/001; C21D 2211/002; C21D 2211/005; C21D 2211/009

(57) ABSTRACT

A method for producing a rolling bearing component includes forming the rolling bearing component from a 100CrMnSi6-4 or 100Cr6 rolling bearing steel, heating the rolling bearing component, quenching the rolling bearing component, heating the rolling bearing component and holding the rolling bearing component. The rolling bearing component to heated to an austenitizing temperature to form an austenitic microstructure. The rolling bearing component is quenched in a hot salt bath to a first temperature of between 170° C. and 200° C. such that there is a pearlitic or ferritic microstructure in a core region of the rolling bearing component. The rolling bearing component is heated to a second temperature between 220° C. and 280° C. The rolling bearing component is held at the second temperature for a holding time of at least 7 hours such that there is a predominantly bainitic microstructure formed on a surface of the rolling bearing component.

### CROSS-REFERENCE TO RELATED APPLICATIONS

This application is the United States National Phase of PCT Appln. No. PCT/DE2022/100353 filed May 10, 2022, which claims priority to German Application Nos. DE102021113276.2 filed May 21, 2021 and DE102022111455.4 filed May 9, 2022, the entire disclosures of which are incorporated by reference herein.

### TECHNICAL FIELD

The present disclosure relates to a method for producing a rolling bearing component, wherein the rolling bearing component is formed from a rolling bearing steel of the type 100CrMnSi6-4 or 100Cr6. Furthermore, the present disclosure relates to a rolling bearing component and a rolling bearing.

### BACKGROUND

DE 10 2006 052 834 A1 discloses a method for producing a rolling bearing ring, in which a bearing ring is produced from a low-alloy, through-hardenable steel with a carbon content of more than 0.5% by weight and total chromium, nickel, and molybdenum content of between 1.4% by weight and 3.0% by weight. The bearing ring undergoes a hardening treatment in which the bearing ring is heated to an external temperature between 800° C. and 880° C. and then quenched until it reaches a temperature below: 150° C.

WO 00/63 455 A1 describes a steel from the SAE52100 series with 0.9 to 1.0% by weight of carbon, 0.15 to 0.40% by weight of silicon, 0.25 to 0.80% by weight of manganese, 1.30 to 1.95% by weight of chromium, a maximum of 0.25% by weight of nickel and 0.05 to 0.35% by weight of molybdenum, with an ultrafine bainite microstructure for use in rolling bearing components. In this context, starting from an austenitic microstructure, cooling is performed from above the martensite starting temperature down to 250° C. and this temperature is typically held for 180 min to produce ultrafine bainite.

DE 10 2006 059 050 A1 discloses a method for the heat treatment of rolling bearing components made of through-hardened, bainitic rolling bearing steel. The method is carried out in two steps, wherein starting from an austenitizing temperature in a salt bath at a temperature in the range of 180 to 210° C., cooling is carried out until temperature equilibrium is reached, followed by a transfer to a second bath for about one hour. The second bath has a temperature of about 220 to 240° C. A uniform bainitic microstructure is produced on the entire component.

US 2010/0 296 764 A1 describes a rolling bearing element made of bearing steel with a through-hardened bainitic and/or martensitic microstructure. Compressive stresses are created on the surface by induction hardening.

EP 0 908 257 A2 describes a method for producing a pinion as a sintered part with a bainitic basic structure. An edge layer consisting of a martensitic microstructure is created by surface hardening.

### SUMMARY

The present disclosure further develops a method for producing a rolling bearing component, a rolling bearing component and a rolling bearing.

In a method according to the present disclosure for producing a rolling bearing component, which is formed from a rolling bearing steel of the type 100CrMnSi6-4 or 100Cr6, in order to form an austenitic microstructure, the rolling bearing component is heated and subsequently quenched in a hot salt bath to a first temperature of between 170° C. and 200° C., such that there is a pearlitic and/or ferritic microstructure at least in the core region of the rolling bearing component. The rolling bearing component is heated immediately thereafter to at least a second temperature in a temperature range of between 220° C. and 280° C. and held for at least 7 hours, and a predominantly bainitic microstructure is formed on the surface of the rolling bearing component.

First, the rolling bearing component is formed from a rolling bearing steel of the type 100CrMnSi6-4 or 100Cr6 by means of a suitable manufacturing process. A suitable rolling bearing steel is 100CrMnSi6-4, which is comparatively inexpensive and still exhibits the desired properties after heat treatment. Alternatively, 100Cr6 is also suitable, as this material is also inexpensive as well as suitable for shell hardening. At the beginning of the heat treatment, the rolling bearing component is heated to the austenitizing temperature and then quenched to the first temperature of between 170° C. and 200° C., wherein the quenching rate is selected such that cracking in the surface of the rolling bearing component is prevented, but at the same time a technically optimal and overrolling-resistant shell is produced on the lateral surface of the rolling bearing component with low distortion. For example, the quenching rate may be selected such that quenching in the upper temperature range occurs faster than the onset of pearlite formation. Furthermore, the quenching rate may be selected depending on the geometry of the rolling bearing component and the quenching medium, i.e., the hot salt bath, e.g., the thermal capacity thereof. The calculation of an optimal quenching rate can be performed in a known manner by means of software. In addition, the quenching rate can be measured during quenching by means of introduced thermocouples.

The core region of the rolling bearing may be cooled at a quenching rate of at most 2 K/s. This enables the formation of the pearlitic and/or ferritic microstructure in the core region of the rolling bearing component.

The term “core region” is understood to mean a region inside the rolling bearing component and at a distance from its surfaces which, in the case of a component such as a solid rolling element, extends from the center of the component over at least 75% of the diameter of the rolling element. In the case of annular rolling bearing components, the core region is also understood to mean a region inside the rolling bearing component and at a distance from its surfaces, which is bounded by the inner diameter and the outer diameter and extends from the center of the wall thickness formed by the inner diameter and the outer diameter over at least 75% of this wall thickness.

During quenching in the hot salt bath, a phase transformation takes place in the microstructure of the rolling bearing component. A substantially pearlitic and/or a substantially ferritic microstructure is formed in the rolling bearing component both on the surface, or in regions near the surface, and in the core region, or in regions remote from the surface of the rolling bearing component. The microstructure that is produced depends substantially on the necessary solution state in the microstructure as well as the alloy composition and the geometry of the rolling bearing component.

By means of the hot salt bath, a comparatively mild quenching effect is achieved, which can be adjusted via the temperature and water content of the hot salt bath.

An example water content here is at least 0.3% by volume. A suitable salt bath is available on the market under the designation AS140 from the manufacturer Durferrit GmbH, Mannheim.

The associated advantages are reduced crack formation due to thermal stress. Furthermore, lower residual stresses can be achieved in rolling bearing components with variable dimensions, size, and weight. The rolling bearing component is quenched in a hot salt bath until the pearlitic and/or ferritic microstructure is achieved at least in the core region. It is possible in this regard that the entire rolling bearing component has assumed the temperature of the hot salt bath. However, it is also conceivable that only part of the rolling bearing component has assumed the temperature of the hot salt bath and another part, e.g., closer to the core of the rolling bearing component, still has a temperature greater than the first temperature. The quenching in the quenching or hot salt bath is conducted in a time-controlled manner.

Ferrite is a single-phase constituent consisting of the ferritic phase of iron. Ferrite forms a polyhedral, twin-free microstructure, is softer than martensite and comparatively easy to form. In particular, the alloy elements chromium and silicon promote the formation of ferrite. A microstructure consisting of ferrite means that the microstructure, e.g., in the core region of the rolling bearing component, consists substantially or largely of ferrite. Thus, the microstructure consists of ferrite even if it is not formed entirely and exclusively by ferrite. Accordingly, even a slight deviation, e.g., of up to 5% by volume, from a completely ferritic microstructure, in which other microstructures can also be present, is still to be understood as a microstructure consisting of ferrite within the meaning of this disclosure.

Pearlite, on the other hand, is a lamellar, eutectoid constituent of steel, i.e., a phase mixture of ferrite and cementite that occurs as a result of coupled crystallization in iron-carbon alloys with carbon contents between 0.02% and 6.67%. Pearlite is softer than martensite. A microstructure consisting of pearlite means that the microstructure, e.g., in the core region of the rolling bearing component, consists substantially or largely of pearlite. Thus, the microstructure consists of pearlite even if it is not formed entirely and exclusively from pearlite. Accordingly, even a slight deviation, e.g., of up to 5% by volume, from a completely pearlitic microstructure, in which other microstructures can also be present, is still to be understood as a microstructure consisting of pearlite within the meaning of this invention.

Mixtures of pearlite and ferrite can also be present in the core region of the rolling bearing component.

After quenching, the rolling bearing component is removed from the hot salt bath and subsequently reheated to at least the second temperature in the temperature range of between 220° C. and 280° C. The second temperature is selected depending on the alloy composition and dimensions of the rolling bearing component. The wording “at least a second temperature in a temperature range of between 220° C. and 280° C.” is to be understood such that the rolling bearing component is kept in a temperature range for a certain amount of time, wherein the temperature can vary within this range depending on the heat treatment strategy, and, for example, can be adjusted incrementally in a targeted manner. It is conceivable to reheat the rolling bearing component exclusively to a single second temperature for the entire treatment time. Alternatively, it is conceivable that several temperatures are set incrementally within the temperature range of between 220° C. and 280° C. in order to set the desired microstructure on the surface or in the region near the surface of the rolling bearing component. The holding time for which the at least second temperature is held in the temperature range of between 220° C. and 280° C. also depends on the heat treatment strategy selected in each case. In any case, the holding time is over 7 hours. In other words, the rolling bearing component is held at a temperature of between 220° C. and 280° C. for at least 7 hours, regardless of what temperatures are approached and held within this range during said time. The second temperature is held until the bainitic microstructure has formed on the surface or in the region near the surface of the rolling bearing component.

In the context of the present disclosure, the wording “immediately thereafter” is to be understood as meaning that the rolling bearing component is not cooled to below 170° C. after it has been quenched from the austenitizing temperature to the first temperature. Instead, quenching is followed by renewed heating of the rolling bearing component to one or more temperatures of between 220° C. and 280° C. for at least 7 hours, so that after heat treatment a predominantly pearlitic and/or ferritic microstructure is present in the core region and a bainitic microstructure or largely bainitic microstructure is present on the surface or in the region near the surface. In other words, quenching is followed by direct reheating of the rolling bearing component.

Bainite is a microstructure that is formed at temperatures below pearlite formation up to martensite formation, both isothermally and with continuous cooling. Upper bainite consists of needle-shaped ferrite arranged in packets. Between the individual ferrite needles there are more or less continuous films of carbides parallel to the needle axis. A distinction must be made between upper bainite and lower bainite, which, on the other hand, consists of ferrite plates within which the carbides form at an angle of 60° to the needle axis. Bainite is also softer than martensite but harder than pearlite. A microstructure consisting of bainite means that the microstructure on the surface or in the region near the surface of the rolling bearing component consists substantially or largely of bainite. Thus, the microstructure consists of bainite even if it is not entirely and exclusively bainite. Accordingly, even a slight deviation from a completely bainitic microstructure, in which other microstructures can also be present, is still to be understood as a microstructure consisting of bainite within the meaning of the present invention. For example, no more than 5% by volume of pearlite may be present in the bainite in the region near the surface. For example, there may be no pearlite at all on the surface of the rolling bearing component.

The rolling bearing component can be formed as a component blank which is formed close to its final geometry, wherein after cooling of the component from the temperature range of between 220° C. and 280° C., further treatment, e.g., mechanical machining, can be carried out in order to bring the rolling bearing component into its final geometry. Alternatively, the component may already be present in the final geometry before heat treatment. The rolling bearing component can be designed, for example, as an inner ring, as an outer ring or as a rolling element of a rolling bearing, and the production and heat treatment of the rolling bearing component proposed here may be particularly suitable for components with large dimensions, e.g., with diameters or thicknesses greater than 85 mm. In other words, the rolling bearing component, which may have a diameter of at least 85 mm, e.g., of 200 mm, is heated in order to form an austenitic microstructure and is subsequently quenched in a hot salt bath to the first temperature, such that there is a pearlitic and/or ferritic microstructure at least in the core region of the rolling bearing component, wherein, immediately thereafter, the rolling bearing component is heated to the at least second temperature of between 220° C. and 280° C. and held in this temperature range for at least 7 hours in order to form the bainitic microstructure on the surface of the rolling bearing component.

The hardenability of the respective steel is determined by the choice of alloy composition. In the case of through-hardenable steels, such as 100CrMnSi6-4, which is considered advantageous here, hardenability can also be modified by changing the carbon content and the content of dissolved alloy elements, such as chromium, via the austenitizing temperature. The required, or necessary for the respective application, solution state for the geometry of the rolling bearing component to be treated and the quenching effect can be determined in advance with the aid of software and/or tests.

The treatment of the rolling bearing component causes residual compressive stresses to be formed on its surface. The residual compressive stresses are realized during the transformation of the microstructure into the bainitic microstructure, which takes place on the surface or in the region near the surface of the rolling bearing component. Residual compressive stresses are negative residual stresses within the microstructure of the component, which result in an improvement of the fatigue strength of the rolling bearing component at the surface. In addition, crack formation is prevented and the corrosion resistance of the rolling bearing component is improved.

Furthermore, the rolling bearing component may be treated in such a way that it has a surface hardness of at least 58 HRC. A hardness of 58 HRC (Rockwell hardness) corresponds to a Vickers hardness of about 655 HV. Consequently, a rolling bearing component according to the disclosure has a hardness of 58 HRC on its surface and a bainitic microstructure. The so-called hardening depth, at which the rolling bearing component has a hardness of 550 HV1 or 52.3 HRC, may be at a depth perpendicular to the surface of the rolling bearing component of about 5.2% of the rolling bearing component thickness or the rolling bearing component diameter. According to DIN 50190-1, the case hardening depth is the perpendicular distance from the surface of the respective component at which the hardness has dropped to a value of 550 HV1. The progression of hardness from the surface to the core is determined by a hardness measurement. The unit HRC consists of HR (Hardness, Rockwell) as a designation of the test method, followed by another letter, here C, which indicates the scale and thus the test forces and bodies. A diamond cone with a 120° point angle and an advance test force of 98.0665 N is used for scale C (C stands for “cone”). The additional test force for scale C is 1372.931 N.

A rolling bearing according to the disclosure includes an outer ring and/or an inner ring as well as a plurality of rolling elements which roll on the outer ring and/or on the inner ring, and the outer ring and/or the inner ring and/or the respective rolling element is a rolling bearing component according to the previous embodiments. In other words, either only the outer ring, only the inner ring, only the rolling elements or any combination of the aforementioned components can be designed as a rolling bearing component which has a pearlitic and/or ferritic microstructure in the core region of the rolling bearing component and a largely bainitic microstructure on the surface of the rolling bearing component.

For example, the rolling bearing component may be designed as a rolling element, which is designed as a solid or hollow roller.

The above statements on the method apply equally to the rolling bearing component according to the disclosure and to the rolling bearing according to the disclosure, and vice versa.

### BRIEF DESCRIPTION OF THE DRAWINGS

Further measures to improve the disclosure are illustrated below together with the description of exemplary embodiments of the disclosure using the figures. In the figures, identical or similar elements are provided with the same reference symbols. In the figures:

FIG. 1 shows a schematic block diagram of a method according to the disclosure for producing the rolling bearing component,

FIG. 2 shows a highly schematic sectional view of a rolling bearing according to the disclosure according to an example embodiment,

FIG. 3 shows a schematic cross-section of a rolling element as a rolling bearing component according to FIG. 2,

FIG. 4 shows a diagram for the rolling bearing steel 100CrMnSi6-4 with a minimum cooling rate based on different austenitizing temperatures over an austenitizing time in order to prevent more than 5% by volume of pearlite in the edge region, and

FIG. 5 shows a diagram which, for the rolling bearing steel 100CrMnSi6-4 and an austenitizing temperature of 855° C., indicates a critical distance to the surface of the rolling element for a pearlite formation of 5% by volume in the edge region as a function of the austenitizing time and thus the degree of austenitization, as well as the diameter of a rolling element.

### DETAILED DESCRIPTION

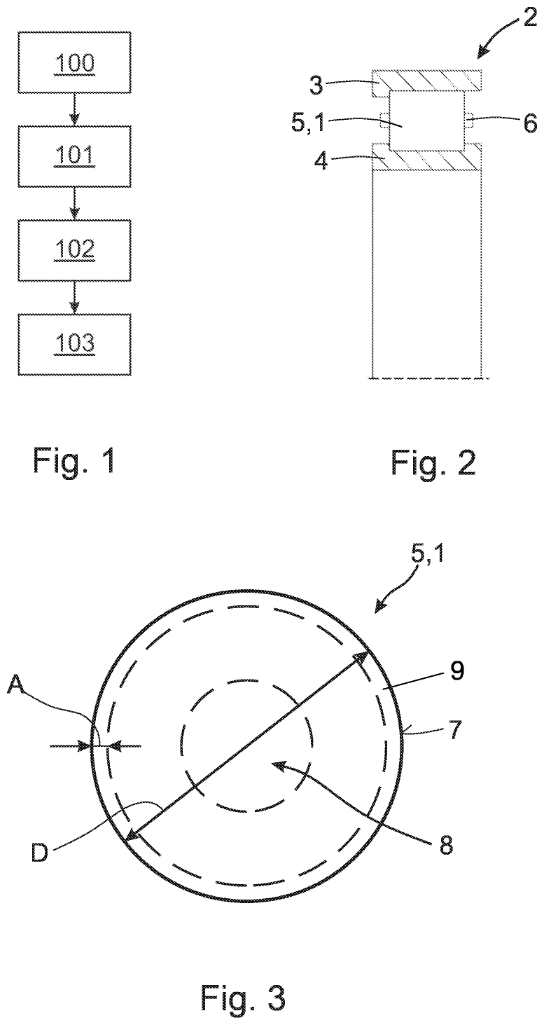

According to FIG. 1, a method according to the disclosure for producing a rolling bearing component 1 designed as a rolling element 5 is visualized in accordance with a block diagram. In the present case, the rolling elements 5 of the rolling bearing 2 are to be understood as the rolling bearing component 1. Such rolling elements 5 can be installed in a rolling bearing 2 according to FIG. 2, namely spatially between an outer ring 3 and an inner ring 4, wherein the rolling elements 5 are arranged and guided spaced apart from one another in the circumferential direction by a cage 6. The rolling element 5 is shown again in cross-section in FIG. 3 for better understanding.

In a first method step 100, the respective rolling element 5, which according to FIGS. 2 and 3 is designed as a cylindrical roller with a diameter D of at least 85 mm, is formed from the rolling bearing steel 100CrMnSi6-4. This can be done by machining, for example. The outer ring 3 and/or the inner ring 4 according to FIG. 2 can also be formed from 100CrMnSi6-4 and produced by the same method according to the disclosure. The production involves heat treatment of the rolling bearing component 1 and is explained below.

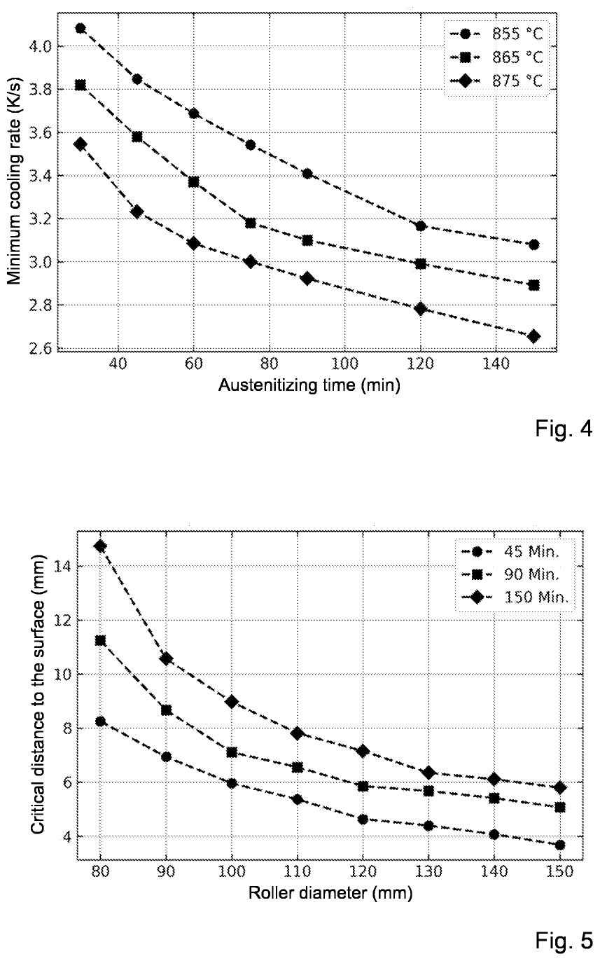

In a second method step 101, the rolling element 5 is heated to a hardening or austenitizing temperature to form an austenitic microstructure and held at this temperature until complete austenitization of the microstructure has taken place, e.g., until a necessary solution state is reached. Subsequently, in a third method step 102, the rolling element 5 is introduced into a hot salt bath and quenched from the austenitizing temperature to a first temperature. Depending on the properties and the mixing ratio of the hot salt bath, the material properties of the rolling bearing component 1 and the austenitizing temperature, the hot salt bath has a temperature of between 170° C. and 200° C. in the present case. The hot salt bath is used to cool the rolling element 5 at a controlled cooling rate (cf. FIG. 4) and with a comparatively mild quenching effect, wherein a phase transformation of the microstructure takes place. In the process, the austenitic microstructure of the rolling element 5 is transformed into a pearlitic and/or ferritic microstructure during quenching. A microstructure consisting of pearlite and/or ferrite is thus formed at least in the core region 8 of the rolling bearing component 1.

After the rolling element 5 has been quenched, it is directly reheated in a fourth method step 103. Specifically, immediately following quenching, the rolling bearing component 1 is heated to at least a second temperature in a temperature range of between 220° C. and 280° C., wherein the at least second temperature is held for at least 7 hours. In other words, the rolling element 5 can be held at a single second temperature for 7 hours. Alternatively, the rolling element 5 can be heated incrementally to several different temperatures within the temperature range of between 220° C. and 280° C. and held there, wherein the total holding time between 220° C. and 280° C. is at least 7 hours. By holding the at least second temperature in the temperature range of between 220° C. and 280° C. for more than 7 hours, a microstructure transformation takes place in which a bainitic microstructure is formed on the surface 7 and in the edge region 9 near the surface of the rolling bearing component 1.

By means of such a heat treatment, rolling bearing components 1 of a shell-hardened design with larger dimensions can be produced more cost-efficiently, since even in the case of materials with a lower alloy content, such a heat treatment produces an overrolling-resistant surface, in the case of the rolling element 5 an overrolling-resistant lateral surface or raceway, and prevents crack formation of the rolling bearing component 1. Furthermore, the heat treatment with the associated microstructure transformation into the bainitic microstructure on the surface 7 sets residual compressive stresses which also prevent crack formation on the rolling element 5. After heat treatment, the rolling element 5 has a surface hardness of at least 58 HRC or 655 HV. At a hardening depth A corresponding to about 5.2% of the diameter D of the rolling element 5, i.e., in this case about 4.4 mm, the rolling element 5 has a hardness of at least 550 HV1. It is conceivable that further heat treatment steps, for example tempering, are carried out in order to reduce the thermally induced stresses within the rolling element 5. Furthermore, a mechanical post-treatment can be carried out in order to bring the rolling element 5 into its final geometry.

FIG. 4 shows a diagram for the rolling bearing steel 100CrMnSi6-4 with a minimum cooling rate in Kelvin per second based on different austenitizing temperatures of 855° C., 865° C. and 875° C. over an austenitizing time in minutes, which must be maintained to prevent formation of more than 5% by volume of pearlite in the rolling bearing steel of this type. It can thus be seen that higher minimum cooling rates have to be set depending on and increasing with the degree of austenitization.

FIG. 5 shows a diagram also for rolling elements with different diameters made of the rolling bearing steel 100CrMnSi6-4 and as a function of an austenitizing time of 45 minutes, 90 minutes and 150 minutes at an austenitizing temperature of 855° C. in each case. With increasing degree of austenitization and with increasing diameter of the rolling elements or roller diameter in millimeters, a critical distance to the surface of the rolling element decreases, corresponding to the hardening depth A between the core region 8 and the surface 7 of the rolling element 5 (cf. FIG. 3), in which the bainitic edge region 9 is located and in which no pearlite formation of more than 5% by volume occurs. Accordingly, the hardening depth A and thus a thickness of the bainitic edge region 9 decreases with increasing diameter D of the roller or rolling element 5 for the same degree of austenitization of the rolling elements 5.

### REFERENCE NUMERALS

1 Rolling bearing component
2 Rolling bearing
3 Outer ring
4 Inner ring
5 Rolling element
6 Cage
7 Surface
8 Core region
9 Edge region
100 First method step
101 Second method step
102 Third method step
103 Fourth method step
A Hardening depth
D Diameter

1. A method for producing a rolling bearing component, wherein the rolling bearing component is formed from a rolling bearing steel of the type 100CrMnSi6-4 or 100Cr6, wherein, in order to form an austenitic microstructure, the rolling bearing component is heated and subsequently quenched in a hot salt bath to a first temperature of between 170° C. and 200° C., such that there is a pearlitic or ferritic microstructure at least in the core region of the rolling bearing component, wherein the rolling bearing component is heated immediately thereafter to at least a second temperature in a temperature range of between 220° C. and 280° C. and held for a holding time of at least 7 hours, wherein a predominantly bainitic microstructure is formed on the surface of the rolling bearing component and residual compressive stresses are generated.

2. The method according to claim 1,
wherein the core region of the rolling bearing component is cooled at a quenching rate of at most 2 K/s.

3. The method according to claim 1,
wherein, for heating to the second temperature, the rolling bearing component [(1)] is transferred to a further bath which has a temperature in the range from 220 to 280° C.

4. The method according to claim 1,
wherein the second temperature is increased incrementally towards 280° C. during the holding time.

5. A rolling bearing component produced by a method according to claim 1,
wherein the rolling bearing component has a bainitic microstructure on the surface and a pearlitic or ferritic microstructure in the core region.

6. The rolling bearing component according to claim 5,
wherein the rolling bearing component has a surface hardness of at least 58 HRC.

7. The rolling bearing component according to claim 5,
wherein rolling bearing component has a diameter (D) of at least 85 mm.

8. A rolling bearing, comprising an outer ring or an inner ring as well as a plurality of rolling elements which roll on the outer ring or on the inner ring, wherein the outer ring or the inner ring or the respective rolling element is a rolling bearing component according to claim 5.

9. A method for producing a rolling bearing component, comprising:
forming the rolling bearing component from a 100CrMnSi6-4 or 100Cr6 rolling bearing steel;
heating the rolling bearing component to an austenitizing temperature to form an austenitic microstructure;
quenching the rolling bearing component in a hot salt bath to a first temperature of between 170° C. and 200° C. such that there is a pearlitic or ferritic microstructure in a core region of the rolling bearing component;
heating the rolling bearing component to a second temperature between 220° C. and 280° C.; and
holding the rolling bearing component at the second temperature for a holding time of at least 7 hours such that there is a predominantly bainitic microstructure formed on a surface of the rolling bearing component.

10. The method of claim 9 wherein, during the quenching, the core region is cooled at a quenching rate that is less than 2 K/s.

11. The method of claim 9 further comprising transferring the rolling bearing component to a further bath with a temperature of 220° C. to 280° C. for the step of heating the rolling bearing component to the second temperature.

12. The method of claim 9 wherein the second temperature is increased incrementally towards 280° C. during the holding time.

13. The method of claim 9 wherein, after the method, the rolling bearing component has a bainitic microstructure on the surface and a pearlitic or ferritic microstructure in the core region.

14. The method of claim 9 wherein, after the method, the rolling bearing component has a surface hardness of at least 58 HRC.

15. The method of claim 9 wherein the rolling bearing component has a diameter (D) of at least 85 mm.
